(19) United States
(12) Patent Application Publication
(10) Pub. No.: US 2025/0061199 A1
(43) Pub. Date: Feb. 20, 2025

(54) ACCELERATING RANSOMWARE RECOVERY USING A COMBINATION OF LOCAL AND REMOTE BACKUPS

(71) Applicant: VMware LLC, Palo Alto, CA (US)

(72) Inventors: Boris Weissman, Palo Alto, CA (US); Sungjoon Ahn, San Jose, CA (US); Derek Uluski, Weymouth, MA (US); Ashish Prajapati, San Jose, CA (US); Henry Dikeman, Mountain View, CA (US); Kiran Kamath, San Jose, CA (US); Lakshmi Narayanan Bairavasundaram, Sunnyvale, CA (US); Ilia Langouev, Santa Cruz, CA (US)

(21) Appl. No.: 18/452,231

(22) Filed: Aug. 18, 2023

(51) Int. Cl. G06F 21/56; G06F 11/14; G06F 21/55

(52) U.S. Cl. CPC G06F 21/568; G06F 11/1469; G06F 21/554

(57) ABSTRACT

Aspects of the disclosure accelerate recovery using a combination of local and remote backups. A backup selector identifies a latest unencrypted remote backup (e.g., created prior to an encrypted backup), a latest unencrypted local backup created prior to the latest unencrypted remote backup, and a penultimate unencrypted remote backup created prior to the latest unencrypted local backup. A restoration manager restores a local computing asset to the state of the latest unencrypted local backup. In a disaster recovery (DR) environment, two differences are generated: one between the latest unencrypted remote backup and the penultimate unencrypted remote backup and another between a newly-generated failback backup and the latest unencrypted remote backup. The two differences are sent to the restoration manager to roll the state of the local computing asset forward in two stages. This approach is faster and reduces egress charges in cloud-based DR environments.

### BACKGROUND

Unlike physical disasters, such as fires and natural disasters, ransomware and some other cyber attacks can result in encrypted backups, complicating recovery. Failback from a ransomware attack requires recovery of the encrypted content, which may involve transfer of large amounts of data from a disaster recovery (DR) service. For large-scale attacks and widespread encryption, failback times may approach initial backup seeding times and are a function of the network speed and the aggregate size of the encrypted content. Cloud-based DR services are common, but typically charge egress fees. Thus, in addition to the extended failback times, recovery from some ransomware attacks also triggers significant cloud egress charges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide solutions for accelerating ransomware recovery using a combination of local and remote backups. Examples include a backup selector that identifies a latest unencrypted remote backup (e.g. a remote backup created prior to an encrypted backup), a latest unencrypted local backup created prior to the latest unencrypted remote backup, and a penultimate unencrypted remote backup created prior to the latest unencrypted local backup. A restoration manager restores a local computing asset, such as a virtual machine (VM), to the state of the latest unencrypted local backup. This stage avoids cloud egress charges when the remote backups are stored in a cloud disaster recovery (DR) environment. At the DR environment, two differences are generated: one between the latest unencrypted remote backup and the penultimate unencrypted remote backup and another between a newly-generated failback backup and the latest unencrypted remote backup. The two differences are sent to the restoration manager to roll the state of the local computing asset forward in two stages to the state of the failback backup.

### BRIEF DESCRIPTION OF THE DRAWINGS

The present description will be better understood from the following detailed description read in the light of the accompanying drawings, wherein:

FIG. 1 illustrates an example architecture that advantageously accelerates ransomware recovery using a combination of local and remote backups;

FIG. 2 illustrates further detail for an example of an architecture that may be used;

FIG. 3 illustrates an example timeline of backups and recovery events that may occur when using an example architecture, such as that of FIG. 1;

FIG. 4 illustrates an example workflow for a three-stage restoration of a computing asset in an example architecture, such as that of FIG. 1;

FIGS. 5 and 6 illustrate examples of various flowcharts of exemplary operations associated with an example architecture, such as that of FIG. 1; and

FIG. 7 illustrates a block diagram of an example computing apparatus that may be used as a component of an example architecture such as that of FIG. 1.

Any of the figures may be combined into a single example or embodiment.

### DETAILED DESCRIPTION

Aspects of the disclosure provide solutions for accelerating ransomware recovery using a combination of local and remote backups. Examples include a backup selector that identifies a latest unencrypted remote backup (e.g. a remote backup created prior to an encrypted backup), a latest unencrypted local backup created prior to the latest unencrypted remote backup, and a penultimate unencrypted remote backup created prior to the latest unencrypted local backup. A restoration manager restores a local computing asset, such as a virtual machine (VM) or other virtual computing instance (VCI), to the state of the latest unencrypted local backup. This stage avoids cloud egress charges when the remote backups are stored in a cloud disaster recovery (DR) environment. At the DR environment, two differences are generated: one between the latest unencrypted remote backup and the penultimate unencrypted remote backup and another between a newly-generated failback backup and the latest unencrypted remote backup. The two differences are sent to the restoration manager to roll the state of the local computing asset forward in two stages to the state of the failback backup. Not only is this approach faster, but the use of the differences reduces cloud egress charges compared with transmitting the complete failback backup.

Aspects of the disclosure improve DR for computing operations by reducing the amount of data transmitted from a remote backup site (e.g., a cloud DR environment) across an external computer network, such as the internet or a private network such as Direct Connect. This improves the functioning of a computing device by using less bandwidth and other network resources. Not only does this improve recovery times from cyber attacks, such as ransomware attacks, but also reduces costs for computing asset owners or users. This advantageous operation is achieved, at least in part, by restoring a local computing asset to a state of a latest unencrypted local backup, further restoring the local computing asset with a difference between the latest unencrypted remote backup and a penultimate unencrypted remote backup, and further restoring the local computing asset with a difference between a failback backup and the latest unencrypted remote backup. Thus, because recovery from cyber attacks is a key aspect of computing, aspects of the disclosure provide a practical, useful result to solve a technical problem in the domain of computing.

While some examples are described in the context of VMs, aspects of the disclosure are operable with any form of VCI. As used herein, a VCI is any isolated software entity that can run on a computer system, such as a software application, a software process, container, or a VM.

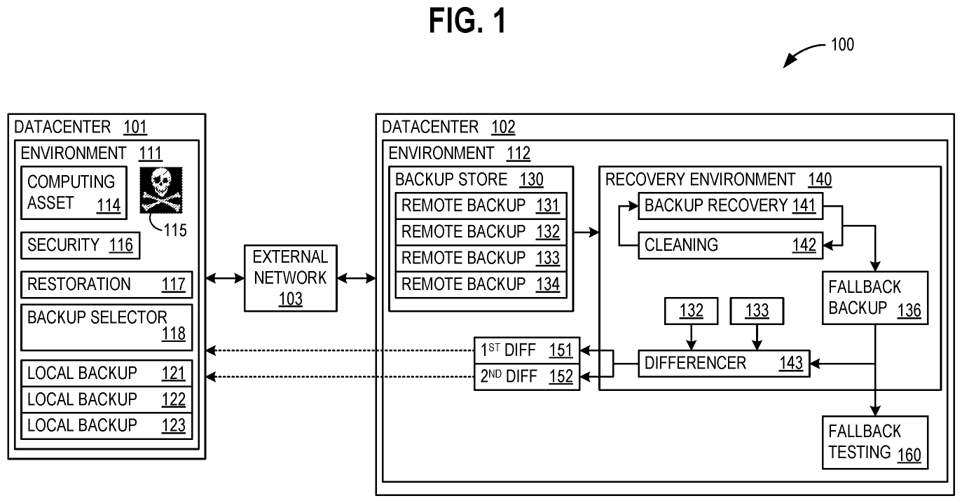

FIG. 1 illustrates an example architecture 100 that advantageously accelerates ransomware recovery using a combination of local and remote backups. In architecture 100, a datacenter 101 hosts a computing environment 111 (e.g., a production site) with a local computing asset 114. In some examples, local computing asset 114 comprises a virtual machine (VM). In the illustrated scenario, ransomware 115 is introduced in a cyber attack, and encrypts local computing asset 114 (or at least a portion), data associated with local computing asset 114, and other computing assets within computing environment 111.

In some examples, a security manager 116 detects the cyber attack, and ceases operations of local computing asset 114 (e.g., suspends, forces a stop), based on at least detecting the cyber attack. In some examples, local computing asset 114 crashes as a result of ransomware 115 (or other aspects of the cyber attack) and security manager 116 detects the cyber attack after the fact. After local computing asset 114 has been restored (recovered), security manager 116 will permit operations of local computing asset 114 to resume.

As a defense against disasters, including natural disasters and cyber attacks, local computing asset 114 is subjected to a series of backups, including local backups and remote backups. Local backups are backups that are within datacenter 101, where local computing asset 114 is operating. Local backups may be available on primary or secondary storage of computing environment 111, across a local private network from computing environment 111 but still within datacenter 101, or may be air gapped from computing environment 111 but available for rapid access due to nearby storage (e.g., on premises).

In contrast, remote backups are stored outside datacenter 101, such as across an external computer network 103 (e.g., the internet or a cloud service's private network) from computing environment 111, in a datacenter 102. In the illustrated example, datacenter 102 hosts a computing environment 112 with a remote backup store 130. In some examples, computing environment 112 comprises a cloud disaster recovery (DR) environment.

Backups may be accomplished by creating a full baseline backup, followed by a series of deltas, which are incremental backups that contain data that has changed since the prior backup (which may be a delta itself). Deltas may be 1% to 5% of the size of the object being backed up (e.g., local computing asset 114). The advantages of smaller backups with deltas has a cost, however. Restoration using a delta backup requires the baseline backup, along with intervening delta backups. In some scenarios, local backups are more likely to be full backups (e.g., a complete VM snapshot) than are remote backups in a typical cloud DR setting.

Local backups may be created for multiple purposes, by different software, such as by dedicated backup software and checkpoint or snapshot functionality, in parallel. In some scenarios, there is little to no coordination among local and remote backup processes, and even local backup processes may be independent. Fortunately, even if various backup processes are managed by different vendors who are not cooperating among each other, aspects of the disclosure are able to implement the advantages described herein—in addition to the recovery speed and cost improvements resulting from less data egress from computing environment 112 described below. For example, the local backups may be created by a first vendor, while the remote backups may be created by a second vendor.

Three local backups are illustrated locally to computing environment 111 (e.g., within datacenter 101), although the count of local backups in some examples may be much larger, or smaller. An unencrypted local backup 121 and a latest unencrypted local backup 122 were both created prior to ransomware 115 fully manifesting itself, and so are not encrypted.

Backing up an encrypted version of local computing asset 114 results in the backup being encrypted. A local backup 123 was created after ransomware 115 encrypted local computing asset 114. Encryption of local computing asset 114 makes even a delta backup of local computing asset 114 large, because all of the encrypted local computing asset 114 will be different than the unencrypted version (e.g., prior to encryption) of local computing asset 114.

A restoration manager 117 restores local computing asset 114 in computing environment 111, using processes described below, in three stages. In the first stage, restoration manager 117 restores local computing asset 114 to the state of latest unencrypted local backup 122. In some examples, this comprises performing an in-place reversion, or basically replacing local computing asset 114 with latest unencrypted local backup 122, if latest unencrypted local backup 122 is a full version of local computing asset 114 (as opposed to a delta). This precludes the need to do a restoration by egressing data from computing environment 112, which would require not only the latest delta, but enough other prior data (e.g., a baseline backup and intervening delta backups) to rebuild a full version of local computing asset 114.

In later stages, restoration manager 117 receives a difference 151 (e.g., between a latest unencrypted remote backup 133 and a penultimate unencrypted remote backup 132), and also a difference 152 (e.g., between a failback backup 136 and latest unencrypted remote backup 133). Failback backup 136 is produced by executing a VM within recovery environment 140, and possibly also patching to remove other vulnerabilities, and is thus both unencrypted and free of infection (e.g., free of ransomware 115).

Restoration manager 117 further restores local computing asset 114 with difference 151 to bring local computing asset 114 up to the state of latest unencrypted remote backup 133 in the second stage. In the third stage, restoration manager 117 further restores local computing asset 114 with difference 152 to bring local computing asset 114 up to the state of failback backup 136. Latest unencrypted remote backup 133, penultimate unencrypted remote backup 132, and failback backup 136 are described below.

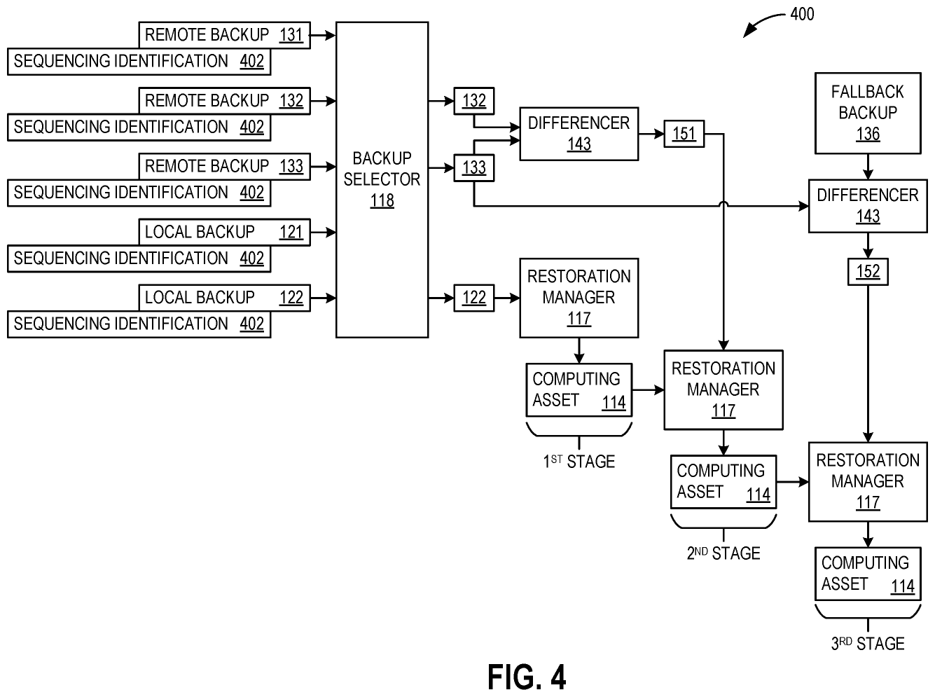

A backup selector 118 identifies latest unencrypted local backup 122, latest unencrypted remote backup 133, and penultimate unencrypted remote backup 132 to restoration manager 117, so that restoration manager 117 knows which backups to use. In some examples, backup selector 118 uses a sequencing identification 402, with which backups annotated, in order to identify the sequencing of backups. Sequencing identification 402 is described in more detail in relation to FIG. 4.

Remote backup store 130 is illustrated as having four backups, although it should be understood that some examples use a larger count of backups. An unencrypted remote backup 131, penultimate unencrypted remote backup 132, and latest unencrypted remote backup 133 were all created prior to ransomware 115 fully manifesting itself, and so are not encrypted. An encrypted backup 134 was created after ransomware 115 encrypted local computing asset 114, and so manifests effects of the cyber attack (e.g., is encrypted)

A recovery environment 140 in computing environment 112 provides data to restoration manager 117 to enable restoration manager 117 to restore local computing asset 114 beyond the state of latest unencrypted local backup 122. In some examples, recovery environment 140 comprises an isolated recovery environment (IRE). Restoration manager 117 (or backup selector 118) identifies the need for a restoration and identifies latest unencrypted remote backup 133 and penultimate unencrypted remote backup 132 to recovery environment 140.

Recovery environment 140 has a differencer 143 that generates difference 151 between latest unencrypted remote backup 133 and penultimate unencrypted remote backup 132 and difference 152 between failback backup 136 and latest unencrypted remote backup 133. Recovery environment 140 transmits difference 151 and difference 152 to computing environment 111.

Recovery environment 140 also has a backup recovery function 141 and a cleaning function 142 that operate in tandem, in a looping or iterative manner, to generate failback backup 136. Failback backup 136 is the closest approximation to the final state of local computing asset 114, prior to encryption by ransomware 115, that recovery environment 140 is able to produce. Generating failback backup 136 may use journaled and other operational data provided by computing environment 111, and techniques are well-known in the art. In some examples, cleaning function 142 removes latent malicious logic (e.g., backdoors and pre-executed versions of ransomware 115, if present) while failback backup 136 is being generated. As used herein, the phrase “clean” allows for some level of malware (malicious logic) such as backdoors and latent attack functionality, but which permits normal operation of the computing asset.

In some examples, failback backup 136 is tested in a failback testing environment 160 prior to recovery environment 140 transmitting difference 152 to computing environment 111. Testing in failback testing environment 160 helps improve confidence that failback backup 136 is properly operational and ransomware 115 will not re-emerge after local computing asset 114 is further restored using difference 152. In some examples, failback backup 136 may also be patched while within failback testing environment 160 to prevent reinfection and also remove other vulnerabilities.

Examples of architecture 100 are operable with virtualized and non-virtualized storage solutions. For example, any of objects 201-204, described below, may correspond to local computing asset 114.

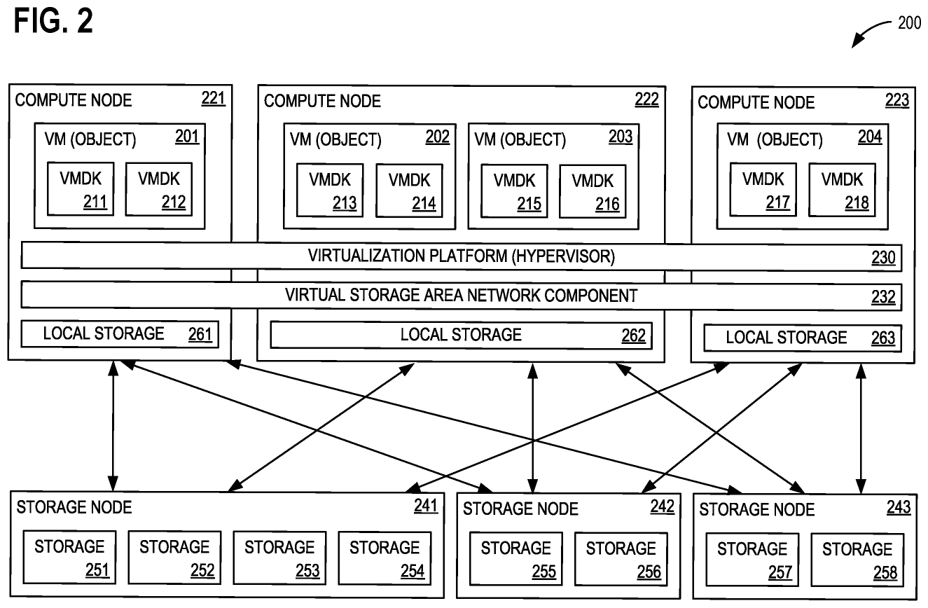

FIG. 2 illustrates a virtualization architecture 200 that may be used as a component of architecture 100. Virtualization architecture 200 is comprised of a set of compute nodes 221-223, interconnected with each other and a set of storage nodes 241-243 according to an embodiment. In other examples, a different number of compute nodes and storage nodes may be used. Each compute node hosts multiple objects, which may be virtual machines, containers, applications, or any compute entity (e.g., computing instance or virtualized computing instance) that consumes storage. A virtual machine includes, but is not limited to, a base object, linked clone, independent clone, and the like. A compute entity includes, but is not limited to, a computing instance, a virtualized computing instance, and the like.

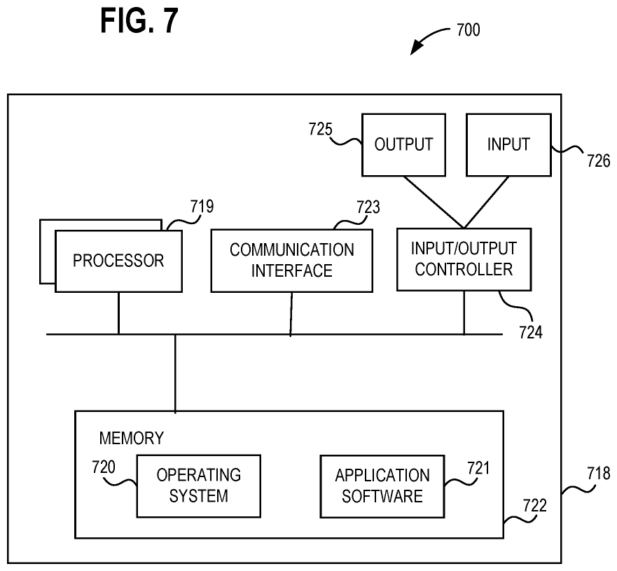

When objects are created, they may be designated as global or local, and the designation is stored in an attribute. For example, compute node 221 hosts object 201, compute node 222 hosts objects 202 and 203, and compute node 223 hosts object 204. Some of objects 201-204 may be local objects. In some examples, a single compute node may host 50, 100, or a different number of objects. Each object uses a VMDK, for example VMDKs 211-218 for each of objects 201-204, respectively. Other implementations using different formats are also possible. A virtualization platform 230, which includes hypervisor functionality at one or more of compute nodes 221, 222, and 223, manages objects 201-204. In some examples, various components of virtualization architecture 200, for example compute nodes 221, 222, and 223, and storage nodes 241, 242, and 243 are implemented using one or more computing apparatus such as computing apparatus 718 of FIG. 7.

Virtualization software that provides software-defined storage (SDS), by pooling storage nodes across a cluster, creates a distributed, shared datastore, for example a SAN. Thus, objects 201-204 may be virtual SAN (vSAN) objects. In some distributed arrangements, servers are distinguished as compute nodes (e.g., compute nodes 221, 222, and 223) and storage nodes (e.g., storage nodes 241, 242, and 243). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 241-243 each include multiple physical storage components, which may include flash, SSD, NVMe, PMEM, and QLC storage solutions. For example, storage node 241 has storage 251, 252, 253, and 254; storage node 242 has storage 255 and 256; and storage node 243 has storage 257 and 258. In some examples, a single storage node may include a different number of physical storage components.

In the described examples, storage nodes 241-243 are treated as a SAN with a single global object, enabling any of objects 201-204 to write to and read from any of storage 251-258 using a virtual SAN component 232. Virtual SAN component 232 executes in compute nodes 221-223. Using the disclosure, compute nodes 221-223 are able to operate with a wide range of storage options. In some examples, compute nodes 221-223 each include a manifestation of virtualization platform 230 and virtual SAN component 232. Virtualization platform 230 manages the generating, operations, and clean-up of objects 201-204. Virtual SAN component 232 permits objects 201-204 to write incoming data from object 201-204 to storage nodes 241, 242, and/or 243, in part, by virtualizing the physical storage components of the storage nodes.

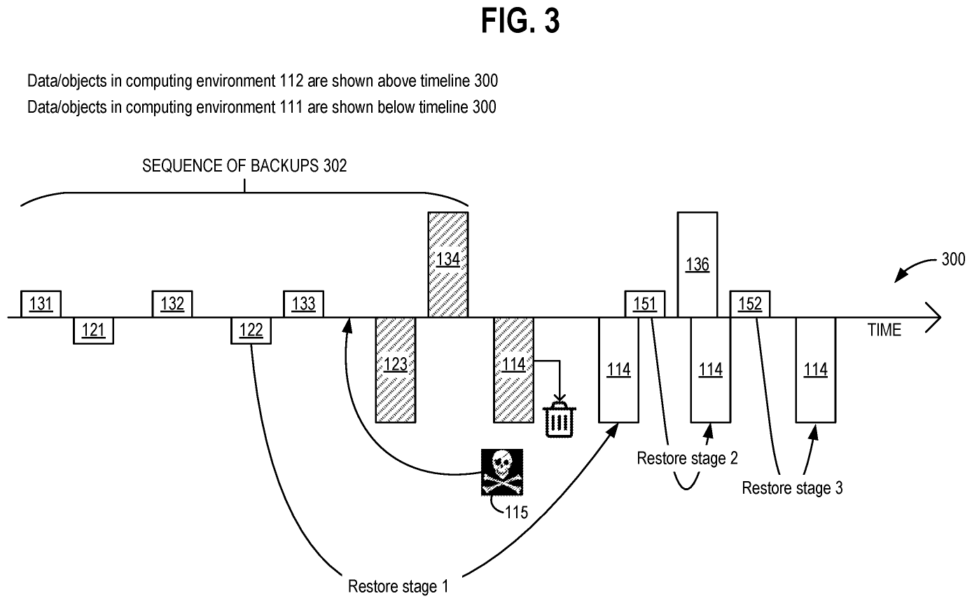

FIG. 3 illustrates an example timeline 300 showing backups and recovery events. Time progresses in the direction of the arrow, from left to right. Starting from the left (earliest in time), a sequence of backups 302 comprises at least unencrypted remote backup 131, penultimate unencrypted remote backup 132, latest unencrypted remote backup 133, and encrypted backup 134. Latest unencrypted remote backup 133 is the most recent remote backup appearing prior to encrypted backup 134 in sequence of backups 302. In some examples, sequence of backups 302 also includes unencrypted local backup 121, latest unencrypted local backup 122, and local backup 123.

Depending on the dwell time before ransomware 115 begins encrypting computing asset 114, any of backups 121, 122, 131, 12, and 133 may be infected, but not encrypted. That is, ransomware 115 is a latent threat in those backups. Encrypted backup 134 is shown as a remote backup. In some examples, latest unencrypted remote backup 133 is the most recent remote backup appearing prior to a remote encrypted backup 134. In some examples, however, an encrypted local backup (e.g., local backup 123) is used as the encrypted backup for purposes of identifying latest unencrypted remote backup 133.

Latest unencrypted local backup 122 is the most recent local backup having been created prior to latest unencrypted remote backup 133, and penultimate unencrypted remote backup 132 is the most recent remote backup having been created prior to latest unencrypted local backup 122. Latest unencrypted local backup 122 contains lesser effects of a cyber attack than does encrypted backup 134 and local backup 123. Ransomware 115 manifests itself and encrypts local computing asset 114 before local backup 123 and encrypted backup 134 are created. Encrypted backup 134 and local backup 123 are shown with shading indicating that they are encrypted, and are shown larger, because even if they are deltas, they will be large, due to encryption. Encrypted backup 134 and local backup 123 are not suitable for restoring local computing asset 114.

The encrypted version of local computing asset 114 is shut down and discarded, as shown. Local computing asset 114 is then restored from latest unencrypted local backup 122 in the first stage of the three-stage restoration process. Difference 151 is created and used to further restore local computing asset 114 in the second stage of the three-stage restoration process. Failback backup 136 is generated, and from it, difference 152 is generated. Local computing asset 114 is then further restored from difference 152 in the third stage of the three-stage restoration process.

FIG. 4 illustrates an example workflow 400 for a three-stage restoration of a computing asset in the example architecture of FIG. 1. Each of unencrypted remote backup 131, penultimate unencrypted remote backup 132, latest unencrypted remote backup 133, unencrypted local backup 121, and latest unencrypted local backup 122 is shown as having a sequencing identification 402. Sequencing identification 402 may be one or more of a timestamp, a sequence number, and an annotation identifying a prior backup. Examples of an annotation identifying a prior backup include latest unencrypted remote backup 133 identifying latest unencrypted local backup 122 or penultimate unencrypted remote backup 132, and latest unencrypted local backup 122 identifying unencrypted local backup 121 or penultimate unencrypted remote backup 132. A sequence number monotonically increases with new backups. In some examples, not all backups have sequencing identification 402.

Backup selector 118 identifies penultimate unencrypted remote backup 132, latest unencrypted remote backup 133, and latest unencrypted local backup 122. Restoration manager 117 uses latest unencrypted local backup 122 to restore local computing asset 114. Differencer 143 generates difference 151 from latest unencrypted remote backup 133 and penultimate unencrypted remote backup 132. Restoration manager 117 uses the first stage version of local computing asset 114 and difference 151 to further restore local computing asset 114.

Differencer 143 generates difference 152 from failback backup 136 and latest unencrypted remote backup 133. Restoration manager 117 uses the second stage version of local computing asset 114 and difference 152 to further restore local computing asset 114. The third stage of local computing asset 114 is what is permitted to return to operations by security manager 116.

With the proper backup operations, the further restoration of local computing asset 114 with difference 151 is an idempotent operation, which is an operation that has no further effect, if called more than once. That is, an idempotent operation is one where f (f (x))=f (x). This is what permits local computing asset 114 to reach the state of latest unencrypted remote backup 133 from the state of latest unencrypted local backup 122, even when latest unencrypted local backup 122 is past the state of penultimate unencrypted remote backup 132. For example, VMware scale-out cloud filesystem (SCFS) provides this advantageous operation, even for delta backups.

This may be explained in the following scenario: A section of a data set is all zeros (0s) in a first backup. The data set is changed, so that the section is changed to all ones (1s). The data set is changed again, so that the section is changed back to all zeros (0s), and a second backup is created. Even though the section of data is the same (all zeros) at the times that the first backup and second backup are created, the second backup should still include the change to all zeros to provide idempotent operation as described above.

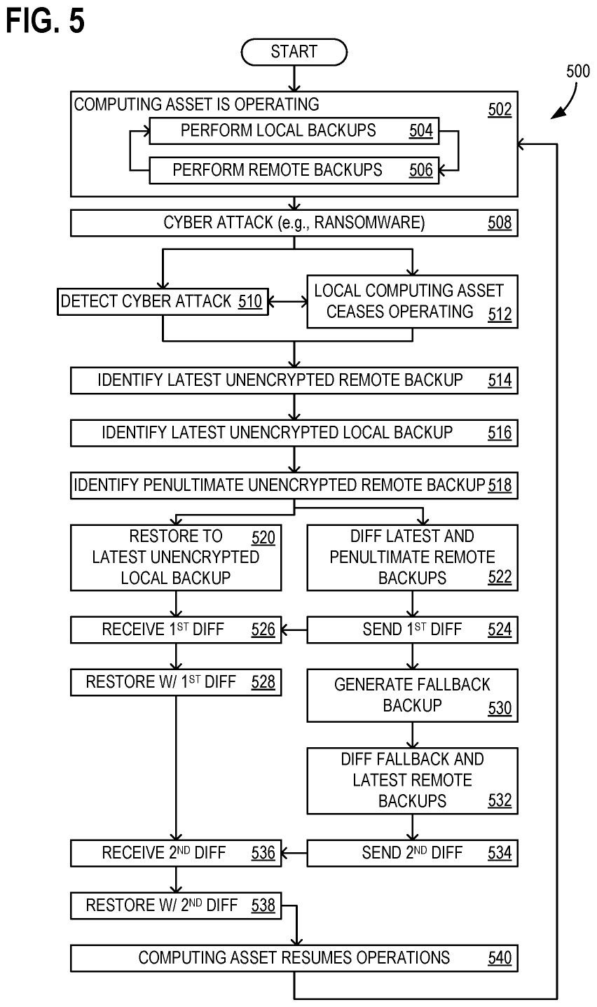

FIG. 5 illustrates a flowchart 500 of exemplary operations that may be performed by examples of architecture 100. In some examples, the operations of flowchart 500 are performed by one or more computing apparatus 718 of FIG. 7. Flowchart 500 commences with local computing asset 114 is operating in box 502. Operation 504 performs local backups (e.g., creates local backups 121-123), and operation 506 performs remote backups (e.g., creates remote backups 131-134). In some examples, operations 504 and/or 506 annotate each (or at least some) backup with one or more of a timestamp, a sequence number, and an annotation identifying a prior backup as sequencing identification 402. If a sequence number is used it is incremented each use. In some examples, operations 504 and 506 do not operate on a common schedule or under common control.

A cyber attack occurs at box 508, such as a ransomware attack that unleashes ransomware 115. The cyber attack encrypts at least a portion of the backups (e.g., local backups 121-123 and remote backups 131-134) and at least a portion of local computing asset 114. The cyber attack is detected in operation 510, and operations of local computing asset 114 cease in operation 512. Operations 510 and 512 may occur in different order, in differing scenarios. In some scenarios, security manager 116 detects the cyber attack and proactively shuts down (or suspends) local computing asset 114 based on at least detecting the cyber attack, although in some scenarios, local computing asset 114 crashes due to the cyber attack and security manager 116 detects the cyber attack as a result of local computing asset 114 crashing.

Latest unencrypted remote backup 133 is identified in operation 514, latest unencrypted local backup 122 is identified in operation 516, and penultimate unencrypted remote backup 132 is identified in operation 518. Any of operations 514-518 may use sequencing identification 402. Local computing asset 114 is restored to the state of latest unencrypted local backup 122 in operation 520.

In parallel with operation 520 being performed in computing environment 111, recovery environment 140 in computing environment 112 performs operations 522 and 524. Operation 522 generates difference 151 and difference 151 is transmitted to computing environment in operation 524. Restoration manager 117 receives difference 151 in operation 526 and further restores local computing asset 114 with difference 151 in operation 528.

In parallel with operation 528 being performed in computing environment 111, recovery environment 140 in computing environment 112 performs operations 530-534. Failback backup 136 is generated in operation 530, difference 152 is generated in operation 532, and difference 152 is transmitted to restoration manager 117 in computing environment 111 in operation 534. Restoration manager 117 receives difference 152 in operation 536 and further restores local computing asset 114 with difference 152 in operation 538.

In operation 540, after local computing asset 114 has been restored with difference 152, local computing asset 114 resumes operations. Flowchart 500 then returns to box 502.

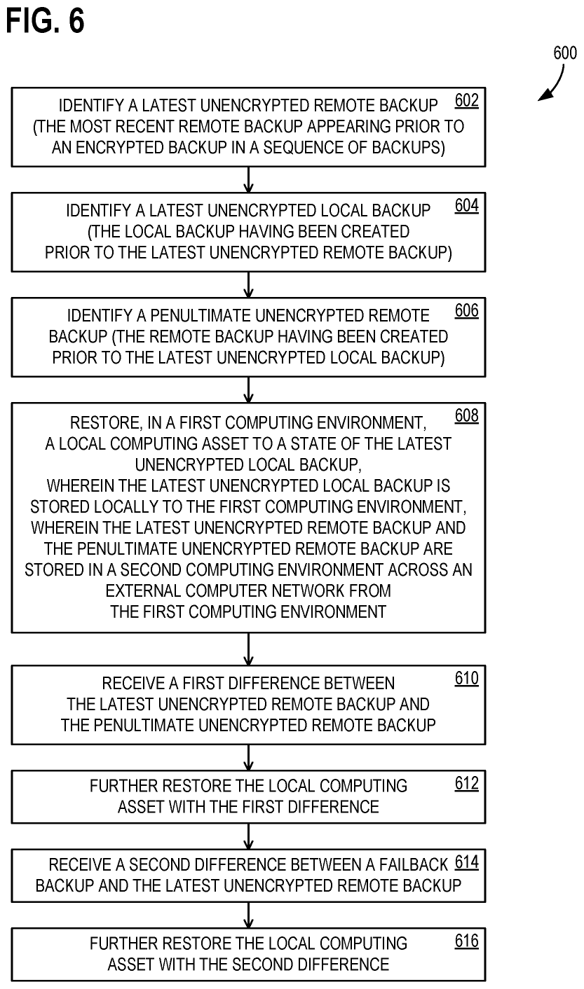

FIG. 6 illustrates a flowchart 600 of exemplary operations that may be performed by examples of architecture 100. In some examples, the operations of flowchart 600 are performed by one or more computing apparatus 718 of FIG. 7. Flowchart 600 commences with operation 602, which includes identifying a latest unencrypted remote backup as a remote backup appearing prior to an encrypted backup in a sequence of backups.

Operation 604 includes identifying a latest unencrypted local backup as a local backup having been created prior to the latest unencrypted remote backup. Operation 606 includes identifying a penultimate unencrypted remote backup as a remote backup having been created prior to the latest unencrypted local backup. Operation 608 includes restoring, in a first computing environment, a local computing asset to a state of the latest unencrypted local backup, wherein the latest unencrypted local backup is stored locally to the first computing environment, and wherein the latest unencrypted remote backup and the penultimate unencrypted remote backup are stored in a second computing environment across an external computer network from the first computing environment.

Operation 610 includes receiving a first difference between the latest unencrypted remote backup and the penultimate unencrypted remote backup. Operation 612 includes further restoring the local computing asset with the first difference. Operation 614 includes receiving a second difference between a failback backup and the latest unencrypted remote backup. Operation 616 includes further restoring the local computing asset with the second difference.

### Additional Examples

An example system comprises: a backup selector identifying a latest unencrypted remote backup as a remote backup appearing prior to an encrypted backup in a sequence of backups; the backup selector identifying a latest unencrypted local backup as a local backup having been created prior to the latest unencrypted remote backup; the backup selector identifying a penultimate unencrypted remote backup as a remote backup having been created prior to the latest unencrypted local backup; a restoration manager restoring, in a first computing environment, a local computing asset to a state of the latest unencrypted local backup, wherein the latest unencrypted local backup is stored locally to the first computing environment, and wherein the latest unencrypted remote backup and the penultimate unencrypted remote backup are stored in a second computing environment across an external computer network from the first computing environment; the restoration manager receiving a first difference between the latest unencrypted remote backup and the penultimate unencrypted remote backup; the restoration manager further restoring the local computing asset with the first difference; the restoration manager receiving a second difference between a failback backup and the latest unencrypted remote backup; and the restoration manager further restoring the local computing asset with the second difference.

An example computerized method comprises: identifying a latest unencrypted remote backup as a remote backup appearing prior to an encrypted backup in a sequence of backups; identifying a latest unencrypted local backup as a local backup having been created prior to the latest unencrypted remote backup; identifying a penultimate unencrypted remote backup as a remote backup having been created prior to the latest unencrypted local backup; restoring, in a first computing environment, a local computing asset to a state of the latest unencrypted local backup, wherein the latest unencrypted local backup is stored locally to the first computing environment, and wherein the latest unencrypted remote backup and the penultimate unencrypted remote backup are stored in a second computing environment across an external computer network from the first computing environment; receiving a first difference between the latest unencrypted remote backup and the penultimate unencrypted remote backup; further restoring the local computing asset with the first difference; receiving a second difference between a failback backup and the latest unencrypted remote backup; and further restoring the local computing asset with the second difference.

One or more example computer storage media have computer-executable instructions that, upon execution by a processor, cause the processor to at least: identify a latest unencrypted remote backup as a remote backup appearing prior to an encrypted backup in a sequence of backups; identify a latest unencrypted local backup as a local backup having been created prior to the latest unencrypted remote backup; identify a penultimate unencrypted remote backup as a remote backup having been created prior to the latest unencrypted local backup; restore, in a first computing environment, a local computing asset to a state of the latest unencrypted local backup, wherein the latest unencrypted local backup is stored locally to the first computing environment, and wherein the latest unencrypted remote backup and the penultimate unencrypted remote backup are stored in a second computing environment across an external computer network from the first computing environment; receive a first difference between the latest unencrypted remote backup and the penultimate unencrypted remote backup; further restore the local computing asset with the first difference; receive a second difference between a failback backup and the latest unencrypted remote backup; and further restore the local computing asset with the second difference.

Alternatively, or in addition to the other examples described herein, examples include any combination of the following:
generating the first difference;
transmitting the first difference;
generating the failback backup;
generating the difference between the failback backup and the latest unencrypted remote backup;
transmitting the difference between the failback backup and the latest unencrypted remote backup to the first computing environment;
generating the failback backup comprises removing malicious logic;
the local computing asset comprises a VM;
identifying the latest unencrypted remote backup, identifying the latest unencrypted local backup, or identifying the penultimate unencrypted remote backup comprises using at least one sequencing identification selected from the list consisting of a timestamp, a sequence number, and an annotation identifying a prior backup;
detecting a cyber attack;
identifying the latest unencrypted remote backup comprises identifying the latest unencrypted remote backup based on at least detecting the cyber attack;
based on at least detecting the cyber attack, ceasing operations of the local computing asset;
after restoring the local computing asset with the second difference, resuming operations of the local computing asset;
the cyber attack comprises a ransomware attack;
the cyber attack encrypts at least a portion of the local computing asset;
the encrypted backup is encrypted by ransomware;
the encrypted backup is a remote backup;
the encrypted backup is a local backup;
the latest unencrypted remote backup is the most recent remote backup appearing prior to the encrypted backup in the sequence of backups;
the latest unencrypted local backup is the most recent local backup having been created prior to the latest unencrypted remote backup;
the latest unencrypted local backup contains lesser effects of a cyber attack than does the encrypted backup;
the latest unencrypted local backup is not stored across the external computer network from the first computing environment;
the latest unencrypted local backup is stored air gapped from the local computing asset;
the penultimate unencrypted remote backup is the most recent remote backup having been created prior to the latest unencrypted local backup;
the second computing environment comprises a cloud disaster recovery environment;
restoring the local computing asset to the state of the latest unencrypted local backup comprises performing an in-place reversion;
restoring the local computing asset to the state of the latest unencrypted local backup comprises replacing the local computing asset with the latest unencrypted local backup;
generating the first difference in the second computing environment;
generating the failback backup in the second computing environment;
generating the difference between the failback backup and the latest unencrypted remote backup in the second computing environment;
annotating each remote backup with at least one sequencing identification selected from the list consisting of: a timestamp, a sequence number, and an annotation identifying a prior backup; and
annotating each local backup with at least one sequencing identification selected from the list consisting of: a timestamp, a sequence number, and an annotation identifying a prior backup.

### Exemplary Operating Environment

The present disclosure is operable with a computing device (computing apparatus) according to an embodiment shown as a functional block diagram 700 in FIG. 7. In an embodiment, components of a computing apparatus 718 may be implemented as part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hardcoded machine. Platform software comprising an operating system 720 or any other suitable platform software may be provided on the computing apparatus 718 to enable application software 721 (program code) to be executed by one or more processors 719. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 718. Non-transitory computer-readable media may include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal per se. Propagated signals per se are not examples of computer storage media. Although the computer storage medium (the memory 722) is shown within the computing apparatus 718, it will be appreciated by a person skilled in the art, that the storage may be distributed or located remotely and accessed via a network or other communication link (e.g. using a communication interface 723). Computer storage media are tangible, non-transitory, and are mutually exclusive to communication media.

The computing apparatus 718 may comprise an input/output controller 724 configured to output information to one or more output devices 725, for example a display or a speaker, which may be separate from or integral to the electronic device. The input/output controller 724 may also be configured to receive and process an input from one or more input devices 726, for example, a keyboard, a microphone, or a touchpad. In one embodiment, the output device 725 may also act as the input device. An example of such a device may be a touch sensitive display. The input/output controller 724 may also output data to devices other than the output device, e.g. a locally connected printing device. In some embodiments, a user may provide input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided, such as via a dialog box or preference setting, to the users of the collection of the data (e.g., the operational metadata) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method comprising:
identifying a latest unencrypted remote backup, the latest unencrypted remote backup being a remote backup appearing prior to an encrypted backup in a sequence of backups;
identifying a latest unencrypted local backup, the latest unencrypted local backup being a local backup having been created prior to the latest unencrypted remote backup;
identifying a penultimate unencrypted remote backup, the penultimate unencrypted remote backup being a remote backup having been created prior to the latest unencrypted local backup;
restoring, in a first computing environment, a local computing asset to a state of the latest unencrypted local backup, wherein the latest unencrypted local backup is stored locally to the first computing environment, and wherein the latest unencrypted remote backup and the penultimate unencrypted remote backup are stored in a second computing environment across an external computer network from the first computing environment;
receiving a first difference between the latest unencrypted remote backup and the penultimate unencrypted remote backup;
further restoring the local computing asset with the first difference;
receiving a second difference between a failback backup and the latest unencrypted remote backup; and
further restoring the local computing asset with the second difference.

2. The computerized method of claim 1, further comprising:
generating the first difference;
transmitting the first difference to the first computing environment;
generating the failback backup;
generating the second difference; and
transmitting the second difference.

3. The computerized method of claim 2, wherein generating the failback backup comprises removing malicious logic.

4. The computerized method of claim 1, wherein the local computing asset comprises a virtual machine (VM).

5. The computerized method of claim 1, wherein identifying the latest unencrypted remote backup, identifying the latest unencrypted local backup, or identifying the penultimate unencrypted remote backup comprises using at least one sequencing identification selected from the list consisting of:
a timestamp, a sequence number, and an annotation identifying a prior backup.

6. The computerized method of claim 1, further comprising:
detecting a cyber attack, wherein identifying the latest unencrypted remote backup comprises identifying the latest unencrypted remote backup based on at least detecting the cyber attack, and wherein the encrypted backup manifests effects of the cyber attack;
based on at least detecting the cyber attack, ceasing operations of the local computing asset; and
after restoring the local computing asset with the second difference, resuming operations of the local computing asset.

7. The computerized method of claim 6, wherein the cyber attack comprises a ransomware attack, wherein the cyber attack encrypts at least a portion of the local computing asset, and wherein the encrypted backup is encrypted by ransomware.

8. A system comprising:
a backup selector identifying a latest unencrypted remote backup, the latest unencrypted remote backup being a remote backup appearing prior to an encrypted backup in a sequence of backups;
the backup selector identifying a latest unencrypted local backup, the latest unencrypted local backup being a local backup having been created prior to the latest unencrypted remote backup;
the backup selector identifying a penultimate unencrypted remote backup, the penultimate unencrypted remote backup being a remote backup having been created prior to the latest unencrypted local backup;
a restoration manager restoring, in a first computing environment, a local computing asset to a state of the latest unencrypted local backup, wherein the latest unencrypted local backup is stored locally to the first computing environment, and wherein the latest unencrypted remote backup and the penultimate unencrypted remote backup are stored in a second computing environment across an external computer network from the first computing environment;
the restoration manager receiving a first difference between the latest unencrypted remote backup and the penultimate unencrypted remote backup;
the restoration manager further restoring the local computing asset with the first difference;
the restoration manager receiving a second difference between a failback backup and the latest unencrypted remote backup; and
the restoration manager further restoring the local computing asset with the second difference.

9. The system of claim 8, further comprising:
a differencer generating the first difference;
a recovery environment transmitting the first difference to the first computing environment;
the differencer generating the second; and
the recovery environment transmitting the second difference to the first computing environment.

10. The system of claim 9, wherein the recovery environment removes malicious logic.

11. The system of claim 8, wherein the local computing asset comprises a virtual machine (VM).

12. The system of claim 8, wherein the backup selector identifies the latest unencrypted remote backup, identifies the latest unencrypted local backup, or identifies the penultimate unencrypted remote backup using at least one sequencing identification selected from the list consisting of:
a timestamp, a sequence number, and an annotation identifying a prior backup.

13. The system of claim 8, further comprising:
a security manager detecting a cyber attack, wherein identifying the latest unencrypted remote backup comprises identifying the latest unencrypted remote backup based on at least detecting the cyber attack, and wherein the encrypted backup manifests effects of the cyber attack;
the security manager ceasing operations of the local computing asset based on at least detecting the cyber attack; and
the security manager permitting operations of the local computing asset to resume after the local computing asset has been restored with the second difference.

14. The system of claim 13, wherein the cyber attack comprises a ransomware attack, wherein the cyber attack encrypts at least a portion of the local computing asset, and wherein the encrypted backup is encrypted by ransomware.

15. One or more computer storage media having computer-executable instructions that, upon execution by a processor, cause the processor to at least:
identify a latest unencrypted remote backup as a remote backup appearing prior to an encrypted backup in a sequence of backups;
identify a latest unencrypted local backup as a local backup having been created prior to the latest unencrypted remote backup;
identify a penultimate unencrypted remote backup as a remote backup having been created prior to the latest unencrypted local backup;
restore, in a first computing environment, a local computing asset to a state of the latest unencrypted local backup, wherein the latest unencrypted local backup is stored locally to the first computing environment, and wherein the latest unencrypted remote backup and the penultimate unencrypted remote backup are stored in a second computing environment across an external computer network from the first computing environment;
receive a first difference between the latest unencrypted remote backup and the penultimate unencrypted remote backup;
further restore the local computing asset with the first difference;
receive a second difference between a failback backup and the latest unencrypted remote backup; and
further restore the local computing asset with the second difference.

16. The computer storage media of claim 15, wherein the computer-executable instructions, upon execution by a processor, further cause the processor to at least:
generate the first difference;
transmit the first difference to the first computing environment;
generate the failback backup;
generate the second difference; and
transmit the second difference to the first computing environment.

17. The computer storage media of claim 16, wherein generating the failback backup comprises removing malicious logic.

18. The computer storage media of claim 15, wherein the local computing asset comprises a virtual machine (VM).

19. The computer storage media of claim 15, wherein identifying the latest unencrypted remote backup, identifying the latest unencrypted local backup, or identifying the penultimate unencrypted remote backup comprises using at least one sequencing identification selected from the list consisting of:
a timestamp, a sequence number, and an annotation identifying a prior backup.

20. The computer storage media of claim 15, wherein the computer-executable instructions, upon execution by a processor, further cause the processor to at least:
detect a cyber attack, wherein identifying the latest unencrypted remote backup comprises identifying the latest unencrypted remote backup based on at least detecting the cyber attack, and wherein the encrypted backup manifests effects of the cyber attack;
based on at least detecting the cyber attack, cease operations of the local computing asset; and
after restoring the local computing asset with the second difference, resume operations of the local computing asset.
